(19) United States
(12) Patent Application Publication
(10) Pub. No.: US 2006/0006323 A1
(43) Pub. Date: Jan. 12, 2006

(54) Method and an apparatus for evaluating toxicity of chemical agents

(76) Inventor: Satoshi Itoh, Niihari-gun (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/174,660

(22) Filed: Jul. 6, 2005

(30) Foreign Application Priority Data
Jul. 7, 2004 (JP) 2004-200585

(51) Int. Cl. G01D 18/00

(52) U.S. Cl. 250/252.1

(57) ABSTRACT

The present invention provides an apparatus for evaluating an interaction between a chemical agent and a receptor, which apparatus comprises, a devise determining an infrared (IR) spectrum of the vicinity of an active center in the receptor and an IR spectrum of the chemical agent, a devise characterizing, by major peak structures thereof, an infrared (IR) spectral structure in the vicinity of the active center in the receptor and an IR spectral structure of the chemical agent, a devise assessing the presence or absence of similarity between the characterized spectral structures.

### CROSS-REFERENCE TO RELATED APPLICATIONS

This application is based upon and claims the benefit of priority from prior Japanese Patent Application No. 2004-200585, filed Jul. 7, 2004, the entire contents of which are incorporated herein by reference.

### BACKGROUND OF THE INVENTION

1. Field of the Invention

The present invention relates to a method and an apparatus for evaluating toxicity of chemical agents. More specifically, the present invention is particularly intended to provide a quick and simple primary toxicity screening and relates to a technique used for safety evaluation in the course of producing novel chemical agents

2. Description of the Related Art

Up to the present time methods to assess the influence of chemical agents on organisms have been mainly performed using whole organisms. The methods used oral ingestion of drugs to animals such as mice, guinea pigs, and rabbits as well as medicating them through exposure and injection to internal organs and then examining the survival rate and changes in shape. Because the results widely vary if whole organisms are used, the toxicity is normally assessed based on the quantity (median lethal dose, LD₅₀) up to when half the number of individual subjects die. Although methods that used these types of whole organisms obtained highly reliable data, in reality they had the following problems.

The first problem is what species to use and how to perform the assessment. Toxicity takes various forms such as acute toxicity, chronic toxicity, carcinogenicity, reproductive toxicity, oncogenicity, teratogenicity, and mutagenicity. Since there are many cases of acute toxicity being related to the metabolic system, the values of LD₅₀ differ greatly depending on the species. Although higher mammals (such as monkeys) can be used if the effect on humans only is taken into consideration, data must be obtained for a large amount of species from the viewpoint of environmental impact. Suitable assessment resources (species, population, scholars, budgets) must be introduced.

The second problem is that currently in spite of the fact that the toxicity assessments as described in the first problem are not possible if very large investments are not made, chemical agents, whose effects on organisms are not well understood, are emerging one after another in industry and are being utilized in products. As with medicinal products, when the products are made to give biological effects (such as to humans), examining the effects on organisms forms a part of development in itself. However, many man-made items, which are not examined in this manner, are considered to only require an extremely limited toxicity assessment. As a result, unexpected environmental problems, such as those represented by dioxins and bisphenol A, are brought about. However, if detailed toxicity assessments are performed for all chemical agents, the use of new materials and new substances will become impossible.

What is desired is a means to quickly and economically judge whether or not it is necessary to seriously investigate the toxicity of materials whose toxicity is not thoroughly understood and then preferentially transfer to a conventional toxicity investigation using whole organisms. A method performed in vitro and a method performed in silico have already been proposed as methods to efficiently perform this primary screening. For example, a method (E-screening method) that uses an MCF-7 (human germ cell) to examine the effects on chemical agents is used for the in vitro method or a method that employs a quantitative structure activity relationship (QSAR method) is used for the in silico method. Compared to the in vivo method, the in vitro method is easier but requires cell cultivation. Because of this, the test equipment becomes more complicated and irregular results will be given. Although there are various methods based on the QSAR method, many of them are based on the similarities of molecular structures (“Toxicity evaluation through manual calculations of chemical agents using QSAR method” Masataka Matsuo, LIC Inc.) For this case, although results with a comparatively high confidence are obtained for evaluations of, for example, isotopes, somewhat unsatisfactory results are obtained when there are different molecular structures. In particular, because a microscopic mechanism is ignored (if forced to describe, a relationship such as one between a key and keyhole is assumed), there were problems which could not be discussed any further.

### BRIEF SUMMARY OF THE INVENTION

The object of the present invention is to provide a simple method to be used for primary screening in toxicity assessment of chemical agents.

The invention provides an apparatus for evaluating an interaction between a chemical agent and a receptor, which apparatus comprises,
a devise determining an infrared (IR) spectrum of the vicinity of an active center in the receptor and an IR spectrum of the chemical agent,
a devise characterizing, by major peak structures thereof, an infrared (IR) spectral structure of the vicinity of the active center in the receptor and an IR spectral structure of the chemical agent, and
a devise assessing the presence or absence of similarity between the characterized spectral structures.

The invention also provides an apparatus for evaluating a physiologically active binding between a chemical agent and a receptor, which apparatus comprises,
a devise determining an infrared (IR) spectrum of the vicinity of an active center in the receptor and an IR spectrum of the chemical agent,
a devise characterizing, by peak structures thereof, an infrared (IR) spectral structure of the vicinity of the active center in the receptor and an IR spectral structure of the chemical agent, and
a devise assessing presence or absence of similarity between the characterized spectral structures.

The invention also provides a method of evaluating an interaction between a chemical agent and a receptor, which method comprises,
selecting a receptor for a chemical agent of interest, determining an infrared (IR) spectrum of the vicinity of an active center of in the receptor and an IR spectrum of the chemical agent,
characterizing, by major peak structures thereof, an infrared (IR) spectral structure of the vicinity of the active center in the receptor and an IR spectral structure of the chemical agent, and
assessing the presence or absence of similarity between the characterized spectral structures.

The invention also provides a method of evaluating a physiologically active binding between a chemical agent and a receptor, which method comprises,
selecting a receptor for a chemical agent of interest,
determining an infrared (IR) spectrum of the vicinity of an active center in the receptor and an IR spectrum of the chemical agent,
characterizing, by major peak structures thereof, an infrared (IR) spectral structure of the vicinity of the active center in the receptor and an IR spectral structure of the chemical agent,
assessing the presence or absence of similarity between the characterized spectral structures.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a flow chart illustrating a procedure of one embodiment of a method according to the invention.

FIG. 2 is block diagram showing one embodiment of an apparatus according to the invention.

FIG. 3 is a schematic view of an interaction to be evaluated by one embodiment of a method according to the invention. The left view represents a chemical agent and a receptor associating together via a strong interaction. The right view represents a chemical agent and a receptor dissociating from each other. When the dissociating chemical agent and the receptor rotate properly to give a correct arrangement of binding areas, they can associate with each other.

FIG. 4 is a graph in which IR spectral structures of the vicinity of an AhR active center and of 2,3,7,8-TCDD are shown overlapped.

FIG. 5 is a graph in which IR spectral structures of indigo and 2,3,7,8-TCDD are shown overlapped.

FIG. 6 is a graph in which IR spectral structures of indigo and AhR receptor are shown overlapped.

### DETAILED DESCRIPTION OF THE INVENTION

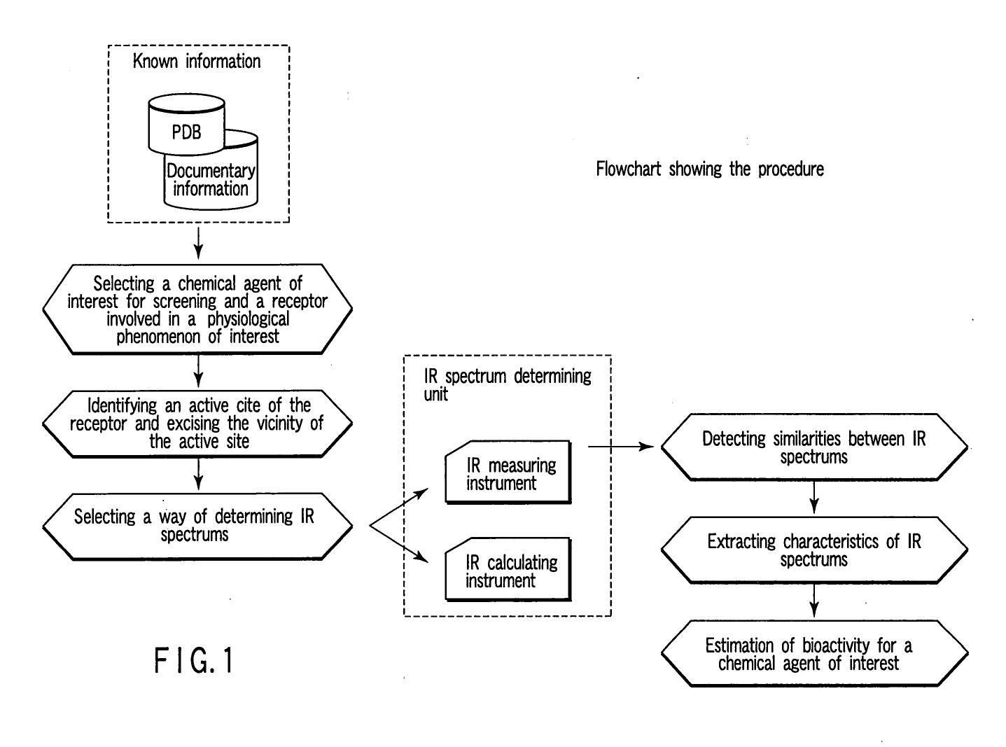

The method of the present invention will now be described taking as an example a case where the method of the present invention is used to evaluate toxicity of chemical agents. The procedure of the method of the invention will be carried out according to a flowchart shown in FIG. 1.

Firstly, in the method according to the invention, receptors are selected from known information, which is involved in a physiological activity to be evaluated. Toxicity of chemical agents will be evaluated by determining whether chemical agents of interest subjected to primary screening can interact with such receptors having an effect on physiological activity. For example, a class of chemical agents to be screened and receptors involved in events for which a particular physiological activity is studied are selected from documents or previous research findings. Characterizations of various receptors made in many previous studies have demonstrated that biological effects caused by chemical agents are mediated by receptors. Receptors involved in a physiological activity of interest will be searched from databases and documents based upon such information. For example, an aryl hydrocarbon receptor, which is known to be a receptor for dioxins, could be mentioned as such receptors. Any receptors could also be selected, which are disclosed in many documents, text books and PDB (Protein Data Bank).

Infrared spectrums are then determined for both the chemical agents subject to primary screening and the receptors (also referred to as “microscopic organ”) that responds to the chemical agent in a living organism. Methods of determining IR spectrums include experimental methods and computational methods. This means that the IR spectrum of a molecule can be obtained either by using a spectrophotometer measuring exciting light and absorption spectrums of a molecule or by numerically solving a quantum chemical primitive equation based on a molecular structure. The selection depends on presence or absence of experimental facilities and computational facilities as well as experience.

The chemical agents subject to screening can easily be measured by an IR-measuring device well known to those skilled in the art, as long as they are readily available by synthesis and the like.

In contrast, the IR spectrum of receptors must be obtained from a vicinity of an active center, not from a whole receptor. Methods of identifying a vicinity of an active center has widely known in the art, and many documents, text books or PDB (Protein Data Bank) listing such results can be referred to for this purpose.

Then, after identification of a vicinity of an active center in a receptor, IR absorption spectrums of the vicinity are determined. For example, a gene for the identified vicinity of an active center in a receptor is excised with a restriction enzyme. The excised gene for the vicinity of an active center is terminated by an appropriate treatment while maintaining its structure. The IR spectrum of a protein expressed from the gene for the vicinity of an active site can be measured with exciting light in an infrared region and a spectrometer. Alternatively, the IR spectrum of a stable structure and a part thereof can be calculated by quantum chemical computation from an amino acid sequence near the receptor.

Subsequently, in order to characterize the measured IR spectrum by peak structures, extraction of characterizations is performed. The extracted similarity is used to identify the similarity of an activity of the chemical agent and an active center part in a receptor in an infrared region. Extraction of characterization is performed with peak structures of the spectrum. Molecules and active center portions of receptors including several tens of atoms will give spectrums with relatively poor structures below approximately 500 cm⁻¹. However, any active centers in receptors and chemical agents with molecular weight of below 1,000 will have sharp peak structures above 1000 cm⁻¹ and one can use these peak structures for extraction of similarity in spectrums. Among peak structures that constitute IR spectrums, peak structures having up to third, fourth, and fifth highest intensity may be used as indices for characterization. Characterization can preferably be made based on peak structures having up to third highest intensity. It will be apparent to those who skilled in the art that whole peak structures of a substance pair to be compared can be expected to have similarity if they have similar peak structures within the range as described above.

Similarity between spectrums is then evaluated based on proximity of peak positions. IR spectrums of naturally occurring molecules range from 0 cm⁻¹ to 4000 cm⁻¹. Since difference of about 1% in this range can be regarded as very small, IR spectrums whose peak structures are within 50 cm⁻¹ are evaluated to have marked similarity. Especially, if difference in frequencies giving the peak structures is within 50 cm⁻¹, preferably 40 cm^{-1, 30} cm^{-1, 20} cm⁻¹ or 10 cm⁻¹, one can assume there is similarity between the IR spectrum of the vicinity of an active center in a receptor and the IR spectrum of the chemical agents. This is obvious from the fact that the difference in frequencies giving peak structures is about 35 cm⁻¹ when compared pairs known to actually interact with each other such as 2,3,7,8-TCDD and an AhR receptor or indigo and an AhR receptor, as shown in the following example. Evaluation of similarity should be made using major peak structures as mentioned above, because minor peak structures are of no physicochemical significance. The result is used for screening of chemical agents as indices for affinity of the receptor and the chemical agents. The screening result can be used as primary screening and preferentially used for subsequent toxicity assessment with whole organisms, i.e. the results can be used to know rank order to give more precise assessment.

According to the present invention, affinities between receptors and chemical agents can be estimated semi-quantitatively by IR spectrum measurement (a relatively simple measuring technique of molecular properties that can be finished in a shorter time) or IR spectrum computation based on information of PDB (a protein database), thereby the effect of chemical agents involved with the receptor. The method provides a rapid screening technique when we study biological activities of chemical agents.

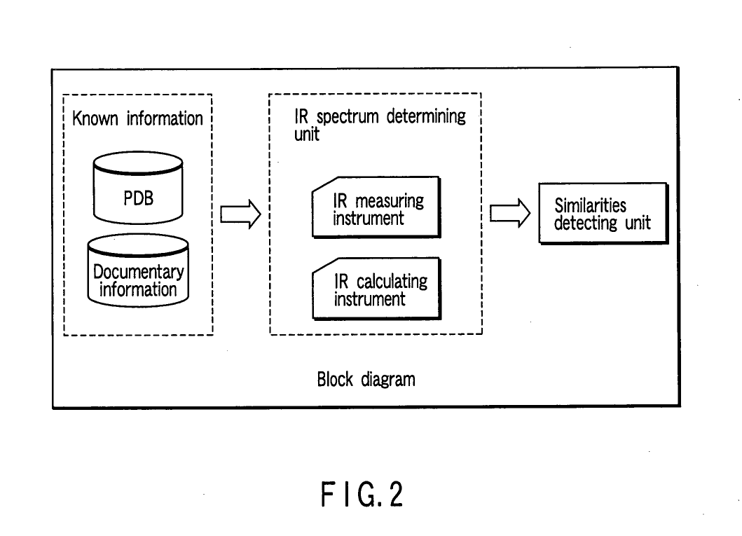

In FIG. 2, a block diagram is shown, which illustrates an apparatus to carry out the method of the present invention. The apparatus comprises a devise determining an infrared (IR) spectrum of the vicinity of an active center of a receptor for a chemical agent of interest and an IR spectrum of the chemical agent (FIG. 2: IR spectrum determining unit). As described above, IR spectrums can be determined experimentally or theoretically. That is, IR spectrums of molecules can be measured either by using a spectrophotometer to measure exciting light (laser beam) and absorption spectrums of a molecule in an infrared region or by numerically solving a quantum mechanical primitive equation based on molecular structures. Accordingly, the apparatus according to the invention could be assumed to be such a spectrophotometer and/or a computer to numerically solve a quantum mechanical primitive equation. Those skilled in the art will select the best configuration for these means.

Users may predetermine a receptor for a chemical agent of interest and the vicinity of an active center thereof or otherwise install, in the apparatus of the invention, a devise selecting a receptor for a chemical agent of interest and its vicinity of an active center. For example, the apparatus of the invention comprises a searching devise searching a receptor involved in a physiological activity of interest from the database PDB (Protein Data Bank) or literatures, based on the information on such receptors known to mediate biological effects by chemical agents. The searching devise as contemplated herein is a computer containing a program that allows such searching.

The apparatus of the invention also comprises a devise characterizing, by major peak structures thereof, an infrared (IR) spectral structure of the vicinity of the active center in the receptor and an IR spectral structure of the chemical agent (FIG. 2 similarity detection unit). The characterizing devise as contemplated herein is a computer containing a program which extracts characteristics of the IR spectrums from information on spectral structures determined by the devise determining IR spectrums as described above and assesses the similarity of activities in an IR absorption region of the chemical agent and the active center part in a receptor. In particular, the characterization will be performed by a program that uses peak structures, as an index for the characterization, having up to the third highest intensity among peak structures that constitute the IR spectrums.

In one embodiment of the apparatus of the invention, the spectrophotometer to measure IR spectrums and the computer containing the program as described above are provided as an all-in-one package.

The use of the apparatus of the invention enables users of the apparatus to evaluate an interaction between a chemical agent and a receptor with ease. That is to say, the users can select a chemical agent of interest and determine its IR spectrum by the IR spectrum determining unit. Users can also search information on the receptor for the chemical agent in a preliminary search or through the search by the searching devise of the apparatus of the invention to determine an IR spectrum of a vicinity of an active center in a receptor for the chemical agent by the IR spectrum determining unit. Similarities of both IR spectrums are assessed in the similarity detecting unit based on the measured IR spectrums of the chemical agent and the receptor. High similarity indicates that the vicinity of an active center in a receptor and the chemical agent are very likely to interact with each other.

In the following example, interaction between chemical agents and its receptors was actually assessed based on the method described above.

### EXAMPLES

Here, an example of an endocrine-disrupting chemical will be given implemented for a type of dioxin that causes especially serious social problems because the reason for its occurrence is due to unintentional factors. Because dioxins are contained in burnable waste of small-scale garbage incinerators in Japan, serious social problems are occurring. A dioxin has the molecular structure shown in the figure below.

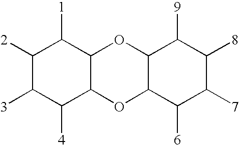

Normally, a hydrogen atom exists at the areas indicated by this numeral although various types of dioxin are possible by replacing this with a chlorine atom. Using this combination a total of 76 types of dioxin isomers are understood. From among these 76 types of dioxin isomers, 2,3,7,8-TCDD is the one examined most often for toxicity. The results are given as TEF (Toxicity Effective Factor) from WHO. Table 1 shows this value.

TABLE 1

| Dioxin isomer | WHO-TEF |
|---|---|
| 2,3,7,8-TCDD | 1 |
| 1,2,3,7,8-PeCDD | 1 |
| 1,2,3,4,7,8-HxCDD | 0.1 |
| 1,2,3,6,7,8-HxCDD | 0.1 |
| 1,2,3,7,8,9-HxCDD | 0.1 |
| 1,2,3,4,6,7,8-HpCDD | 0.01 |
| OCDD | 0.0001 |

This shows the level of the toxicity intensity of other dioxin isomers especially when the toxicity intensity of 2,3,7,8-TCDD is set to be 1. When discussing total emissions of dioxins as an environmental problem, convert the total emissions to 2,3,7,8-TCDD equivalent and obtain a quantitative understanding according to the intensity ratio. Consequently, this TEF value is very important.

A considerable portion of the microscopic mechanism effect the dioxins pass to organisms have been elucidated. An organism exposed to chemical agents takes in the chemical agents by means of receptors. The organism's metabolic system metabolizes the chemical agents through a reaction such as a glucuronide conjugation reaction and then discharges the agents outside the body. A receptor that uses dioxins as ligands is an AhR aryl hydrocarbon receptor. An AhR is a receptor that uses not only dioxins but also many PAHs (Polycyclic Aromatic Hydrocarbons) as ligands. In the following, an example of an assessment of the interaction between dioxins and AhR for the purpose of screening will be described.

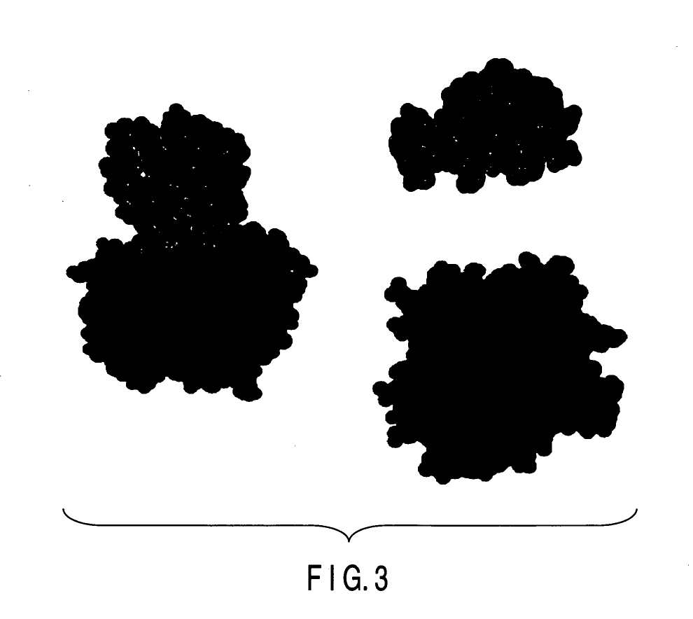

At first, measure the IR spectrum of the dioxin molecules using an ordinary spectrometer. The spectrum can also be found by a quantum chemical calculation. The spectrum in 2,3,7,8-TCDD was obtained as shown in FIG. 3. The characteristics of the IR spectrum of this chemical compound have several sharp peak structures and in particular, a large peak close to 1500 cm⁻¹ as a main peak.

In contrast, measure the IR spectrum of the vicinity of an active center in AhR. It is understood that a PAS domain exists at the active center in AhR. The amino acid sequence that comprises the PAS domain is entered in a PDB (public database) making it possible to find the core amino acid sequence from that database. It is also possible to find the portion that is the core of the active center and the peripheral amino acid sequence using the PDB. Because of this, protein fragments close to the active center can be obtained by a method such as searching close to the active center based on a PDB database and then excising the genes of the active center portion using a restriction enzyme. This makes it possible to measure the IR spectrum for these protein fragments. In addition, the IR spectrum can also be found by calculations using the amino acid sequence close to the active center.

Next, compare the IR spectral structure (thin lines) close to the active center to the IR spectral structure of 2,3,7,8-TCDD (thick lines). FIG. 3 shows both IR spectrums layered on each other. The vertical axis in the figure is the IR absorption intensity and only has the meaning of a relative value and not an absolute value.

Subsequently, if the IR spectral structure close to the active center in AhR is characterized, the IR spectral structure close to the active center in AhR has a main peak structure of 3000 cm^{-1, 1800} cm⁻¹, and 1500 cm⁻¹, respectively. In contrast, the principal 2,3,7,8-TCDD is close to near 1500 cm⁻¹. If we focus on this peak structure, it is understood that the spectrum of the active center in AhR is overlapping. The IR spectrum is a spectrum in which optical absorption that occurs due to the conversion of photon energy into molecular vibration energy is measured. In other words, the overlapping of these peaks means the active center in AhR and its ligand, 2,3,7,8-TCDD, have similar vibrational levels. Since mode coupling is likely to occur between close energy levels, this may cause interaction. This is related to the fact that 2,3,7,8-TCDD is a ligand for AhR. By focusing on this, the affinity between AhR can be estimated.

In order to confirm this, an IR spectrum was also obtained from a 1,2,3,4-TCDD that is a dioxin isomer without any reported toxicity. The peak structure exists naturally although that position is shown shifted from near 1500 cm⁻¹. As a result, we expect that the affinity between the AhR of the 1,2,3,4-TCDD not be high. This low affinity is actually related to low toxicity.

Although the relationship described above is determined by the relationship between the ligand and the receptor, it is assumed that chemical agents with a high affinity towards AhR will migrate into nuclear through AhR and have an effect on genetic information expression. This is an important point when screening chemical agents.

Next, indigo will be discussed as a chemical agent different from a dioxin isomer. Indigo is an artificial dye created for the first time by humans and at the present time is a substance used in large quantities. In 2002 Matsui et al of Kyoto University published “Searching for New Internal Secretion Disturbance Materials using an HPLC Bioassay Method” (Saburo Matsui, Tomonari Matsuda) Endocrine Disrupter NEWS LETTER, 5(1), 3 (2002) which showed that indigo has a strong affinity with AhR. A property shared by dioxins and indigo is the fact that their molecular structure is comprised two aryl groups although there is almost no topological correlation. Furthermore, the chemical properties are also considered to be different. The toxicity of indigo are comparatively low and indigo is used as a dye because it has a blue color absorption band and no endocrine-disrupting property has been reported.

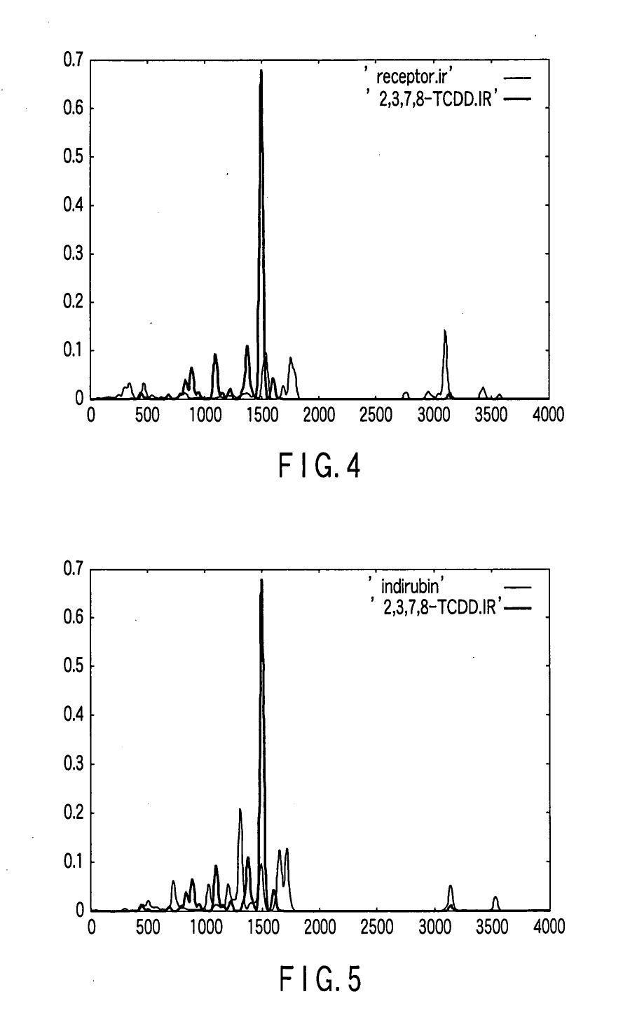

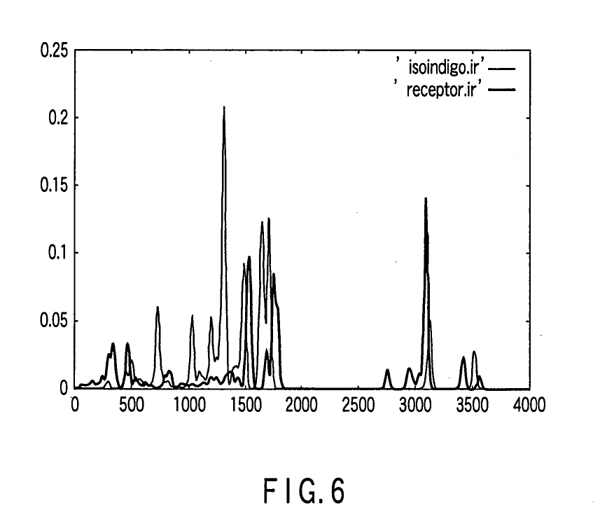

FIG. 4 shows the IR spectrum of indigo (thin lines) and 2,3,7,8-TCDD (thick lines). Even though these two spectrums are quite different, the IR spectrum of indigo also has a peak structure at the position of the large peak of 2,3,7,8-TCDD close to 1500 cm⁻¹. This peak is the third peak when considering the intensity ratio (the second peak close to 1700 cm⁻¹ is split into a doublet). As a result, the affinity between AhR can also be estimated from this analysis. This has also been verified by a sensitive analysis using HPLC as in the previous report of Matsui et al. HPLC has much higher accuracy compared to measuring the IR spectrum but requires large-scale equipment. If measuring the IR spectrum can perform a certain degree of screening, ideally HPLC should be used for subsequent detailed analysis. In addition, the IR spectrum of indigo (thin lines) and AhR receptors (thick lines) is as shown in FIG. 5. When comparing both, the similarities are quite high and the structure is seen in the IR spectrum of the AhR receptor at the region corresponding to the doublet structure close to not only 1500 cm⁻¹ but also 1700 cm⁻¹ where indigo exists. Although the role of an AhR receptor inside an organism is not fully understood, dioxins and PAH compounds are at least not biological material. Indigo does not exist inside the human body although similar compounds are often seen comparatively speaking. An AhR receptor is more than likely a receptor that employs this type of material as a ligand. Therefore, this method assesses the effects of not only toxicity assessments or environmental burdens of chemical agents on organisms but also can be used to estimate ligands of unknown receptors (namely, the physiological role is not known, so-called orphan receptor) inside an organism. And in addition, this method can also adapt to the design of drug (such as inhibitors) which exhibit their effects by blocking receptors. This method has been shown to be sufficiently used for screening aside from life sciences.

Additional advantages and modifications will readily occur to those skilled in the art. Therefore, the invention in its broader aspects is not limited to the specific details and representative embodiments shown and described herein. Accordingly, various modifications may be made with out departing from the spirit or scope of the general inventive concept as defined by the appended claims and their equivalents.

What is claimed is:

1. An apparatus for evaluating an interaction between a chemical agent and a receptor, comprising,
a devise determining an infrared (IR) spectrum of the vicinity of an active center in the receptor and an IR spectrum of the chemical agent,
a devise characterizing, by major peak structures thereof, an infrared (IR) spectral structure in the vicinity of the active center in the receptor and an IR spectral structure of the chemical agent, and
a devise assessing the presence or absence of similarity between the characterized spectral structures.

2. An apparatus according to claim 1, wherein characterization by the devise characterizing the IR spectral structures is made based on assuming that the IR spectrums of the vicinity of the active center in the receptor and the chemical agent have similarity when a difference in frequencies giving the peak structures is within 50 cm⁻¹, wherein a peak structure having up to the third highest intensity is selected as an index for the characterization among peak structures that constitutes the IR spectrums.

3. An apparatus according to claim 1, wherein the devise determining the IR spectral structures is either a devise experimentally determining the IR spectral structures of the chemical agent and/or of the vicinity of the active center in the receptor of interest dissolved in solvent using laser beam and a spectrophotometer, a devise theoretically determining the IR spectral structures from a molecular structure based on quantum mechanistic theories, or a combination thereof.

4. An apparatus according to claim 2, wherein the devise determining the IR spectral structures is either a devise experimentally determining the IR spectral structures of the chemical agent and/or of the vicinity of the active center in the receptor of interest dissolved in solvent using laser beam and a spectrophotometer, a devise theoretically determining the IR spectral structures from a molecular structure based on quantum mechanistic theories, or a combination thereof.

5. An apparatus for evaluating a physiologically active binding between a chemical agent and a receptor comprising,
a devise determining an infrared (IR) spectrum of the vicinity of an active center in the receptor and an IR spectrum of the chemical agent,
a devise characterizing, by major peak structures thereof, an infrared (IR) spectral structure of the vicinity of the active center in the receptor and an IR spectral structure of the chemical agent, and
a devise assessing presence or absence of similarity between the characterized spectral structures.

6. An apparatus according to claim 5, wherein characterization by the devise characterizing the IR spectral structures is made based on assuming that the IR spectrums of the vicinity of the active center in the receptor and the chemical agent have similarity when a difference in frequencies giving the peak structures is within 50 cm⁻¹, wherein a peak structure having up to the third highest intensity is selected as an index for the characterization among peak structures that constitutes the IR spectrums.

7. An apparatus according to claim 5, wherein the devise determining the IR spectral structures is either a devise experimentally determining the IR spectral structures of the chemical agent and/or of the vicinity of the active center in the receptor of interest dissolved in solvent using laser beam and a spectrophotometer, a devise theoretically determining the IR spectral structures from a molecular structure based on quantum mechanistic theories, or a combination thereof.

8. An apparatus according to claim 6, wherein the devise determining the IR spectral structures is either a devise experimentally determining the IR spectral structures of the chemical agent and/or of the vicinity of the active center in the receptor of interest dissolved in solvent using laser beam and a spectrophotometer, a devise theoretically determining the IR spectral structures from a molecular structure based on quantum mechanistic theories, or a combination thereof.

9. A method of evaluating an interaction between a chemical agent and a receptor, which method comprises,
selecting a receptor for a chemical agent of interest,
determining an infrared (IR) spectrum of the vicinity of an active center in the receptor and an IR spectrum of the chemical agent,
characterizing, by major peak structures thereof, an infrared (IR) spectral structure of the vicinity of the active center in the receptor and an IR spectral structure of the chemical agent, and
assessing the presence or absence of similarity between the characterized spectral structures.

10. A method according to claim 9, wherein characterization by the devise characterizing the IR spectral structures is made based on assuming that the IR spectrums of the vicinity of the active center in the receptor and the chemical agent have similarity when a difference in frequencies giving the peak structures is within 50 cm⁻¹, wherein a peak structure having up to the third highest intensity is selected as an index for the characterization among peak structures that constitutes the IR spectrums.

11. A method according to claim 9, wherein the IR spectral structures are determined by experimentally determining the IR spectral structures of the chemical agent and/or of the vicinity of the active center in the receptor of interest dissolved in solvent using laser beam and spectrophotometer, by theoretically determining the IR spectral structures from a molecular structure based on quantum mechanistic theories, or by a combination thereof.

12. A method of according to claim 10, wherein the IR spectral structures are determined by experimentally determining the IR spectral structures of the chemical agent and/or of the vicinity of the active center in the receptor of interest dissolved in solvent using laser beam and spectrophotometer, by theoretically determining the IR spectral structures from a molecular structure based on quantum mechanistic theories, or by a combination thereof.

13. A method for evaluating toxicity of a chemical agent by evaluating a physiologically active interaction between the chemical agent and a receptor therefore using the method according to claim 9.

14. A method for evaluating toxicity of a chemical agent by evaluating a physiologically active interaction between the chemical agent and a receptor therefore using the method according to claim 10.

15. A method for evaluating toxicity of a chemical agent by evaluating a physiologically active interaction between the chemical agent and a receptor therefore using the method according to claim 11.

16. A method for evaluating toxicity of a chemical agent by evaluating a physiologically active interaction between the chemical agent and a receptor therefore using the method according to claim 12.

17. A method according to claim 9, wherein the interaction between the chemical agent and the receptor is a physiologically active binding between the chemical agent and the receptor.

18. A method according to claim 10, wherein the interaction between the chemical agent and the receptor is a physiologically active binding between the chemical agent and the receptor.

19. A method according to claim 11, wherein the interaction between the chemical agent and the receptor is a physiologically active binding between the chemical agent and the receptor.

20. A method according to claim 12, wherein the interaction between the chemical agent and the receptor is a physiologically active binding between the chemical agent and the receptor.
